(19) United States
(12) Patent Application Publication
(10) Pub. No.: US 2018/0330711 A1
(43) Pub. Date: Nov. 15, 2018

(54) LIGHTWEIGHT ACOUSTIC REFLECTOR

(71) Applicant: Subsea Asset Location Technologies Limited, Dorset (GB)

(72) Inventor: Carl TILTMAN, Dorset (GB)

(21) Appl. No.: 15/774,079

(22) PCT Filed: Nov. 10, 2016
(86) PCT No.: PCT/GB2016/053511

§ 371 Date: May 7, 2018

(30) Foreign Application Priority Data
Nov. 10, 2015 (GB) 1519839.3
Nov. 10, 2015 (GB) 1519840.1

(51) Int. Cl. G10K 11/20

(52) U.S. Cl. CPC G10K 11/205

(57) ABSTRACT

An underwater acoustic reflector (10) comprising a shell (13) surrounding a core (16) in which the core (16) comprises a foamed silicon elastomer and the shell (13) a composite board material.

### TECHNICAL FIELD

This invention related to an underwater water acoustic reflector.

### BACKGROUND ART

Existing sonar pingers to identify acoustic transmissions from aircraft downed in water operate at 37.5 kHz and have a range of 1 to 2 Km within which they can be detected from the water surface in normal conditions and 4 to 5 km in good conditions. In very deep water no acoustic signal will reach the surface. The usual criterion is that the towed pinger locator used to identify the presence of an aircraft underwater must be within 1.8 km of the pinger to detect it.

WO 2011/012877 A (SUBSEA ASSET LOCATION TECHNOLOGIES LIMITED) Mar. 2, 2011 describes and acoustic reflector for use underwater. However the embodiments described generally comprise a solid single case silicon or butyl elastomer core in a shell comprising, for example, aluminium, aluminium alloy or glass reinforced polyphthalamide. The reflectors with shells shell comprising glass reinforced polyphthalamide generally are not very effective at 37.5 KHZ and those with aluminium or aluminium alloy shells, although effective at that frequency are too heavy to be deployed in aircraft.

A further problem with existing detection systems for downed aircraft underwater is that there are very few detection systems operating at 37.5 kHz to allow widespread and rapid deployment in the event of an incident.

On the other hand sonar equipment operating at 8.8 KHz is widely used in the fishing industry, and a sonar reflector reflecting acoustic waves underwater at that frequency, and which was much lighter than existing acoustic reflectors would widely deployable both in aircraft to aid recovery, in the fishing industry to mark nots and the like, and as a marker generally for underwater structures without the need to employ specialist or specially adapted sonar equipment. Furthermore as low frequency sonar will travel greater distances underwater, realisation of such a device would enable its detection over a much greater area of sea than existing reflectors which do not operate at such low frequencies.

### DISCLOSURE OF INVENTION

According to the present invention an underwater acoustic reflector comprises a shell surrounding a core wherein said shell permits acoustic waves at one or more frequencies to pass, in part at least, through the shell into the core to be reflected back from the shell opposite the entry of the acoustic wave and in which the shell has one or more holes therein permitting water freely to enter and leave the inside of the shell when the reflector is deployed in water and in which the core comprises a foamed silicon elastomer and the shell a composite board material.

In a preferred embodiment the core comprises foamed RTV12.

In one such an embodiment the shell comprises carbon fibre lamellas impregnated with epoxy resin and a two component thixotropic adhesive.

A suitable foaming silicon elastomer based on RTV 12 is sold under the trade name RTF7000 by Silicon Solutions Ltd of Unit H2, Europa Way, Stoneclough Road, Radcliffe, Manchester, M26 1GG United Kingdom. A suitable carbon fibre lamellas composite board material is sold under the trade name Silosyst™ by 5M sro, Na Zähonech 1177, 686 04 Kunovice, Czech Republic.

As an alternative the shell comprises a sandwich with glass fibre or carbon fibre sheet as covers and polymer honeycomb as a between the sheets (a typical material is known as Puroxt®).

Preferably the thickness of the shell is 9 mm to 11 mm inclusive, more preferably the thickness is 9 mm.

A further possible shell material comprises glass fibre lamellas impregnated with epoxy resin and a thixotropic adhesive.

Surprising and unexpectedly the range at which the presence of such a reflector has been detected is up to 18 km away underwater (the anticipated specified normal range would be 12 km) using a sonar system operating at 8.8 kHz, which is much mover than the frequencies at which the reflectors described in WO2011/012877 and which is a frequency at which many common echo sounders used in the fishing industry operate. This thus enables a system for aiding the location of aircraft underwater which will remain operational for a long requiring minimal maintenance, and which can be interrogated with sonars and receivers which are very commonly available avoiding the delay associated with bringing specialist sonars and receivers to the suspected site. Further, the range at which the reflectors can be detected enables the density of searching to be reduced compared with existing systems.

A further advantage of the reflectors as used in the present invention is that they are very light compared to those whose manufacture is described in WO011/012877.

The density of the foam core can be varied when the core is manufactured by changing the pressure at which a mould for the core is filled; typically the fill pressure is around 1.5 bar giving an acoustic velocity of 890 m/s. The preferred shell, comprising carbon fibre lamellas, has an acoustic velocity of 2531 m/s, giving a ratio of acoustic velocity of the shell to the acoustic velocity of the core of 2.84 which is within the identified most preferable range for this ratio set out in WO 2011/012877 of 2.74 to 2.86.

The weight of the reflectors whose manufacture is described in WO2011/012877 is 2.6 kg for a 150 mm diameter reflector operating at 37 kHz (the current standard frequency for aircraft pingers); such a reflector has an a detectable range of 4.4 km in deep water. To increase the range to 7.4 km in deep water requires a reflector 66 kg in weight and 450 mm in diameter, something that is clearly impractical for aircraft application both in terms of size and weight. In contrast a 150 mm reflector designed as part of this invention has a weight of just over 0.8 kg with a deep water range of up to 18 km, clearly a much more practical option of aircraft deployment.

Quite apart from deployment to identify down aircraft, the acoustic reflectors of the present invention are highly useful in trawl nets, where their lightness provides considerable advantage over existing systems.

### BRIEF DESCRIPTION OF DRAWINGS

Examples of the invention will be more fully described with reference to the accompanying drawings, in which

FIGS. 1 and 2 show side and plan views of a hemispherical shell component for a spherical acoustic reflector for use in the present invention;

FIG. 3 shows a core for an acoustic reflector for use with the hemispherical shell pieces of FIGS. 1 and 3;

FIG. 4 is a cross section of the acoustic reflector made using two hemispherical shells as shown in FIGS. 1 and 2;

FIG. 5 shows the deployment of a trawl net equipped with the invention; and

FIG. 6 illustrates schematically the application of the present invention to a trawl net, for clarity in FIG. 6 the trawl net itself is omitted.

### BEST MODE FOR CARRYING OUT THE INVENTION

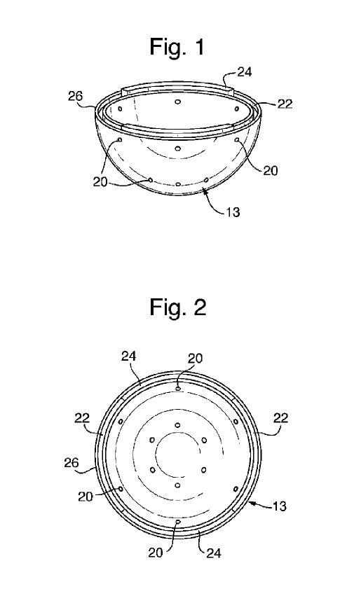

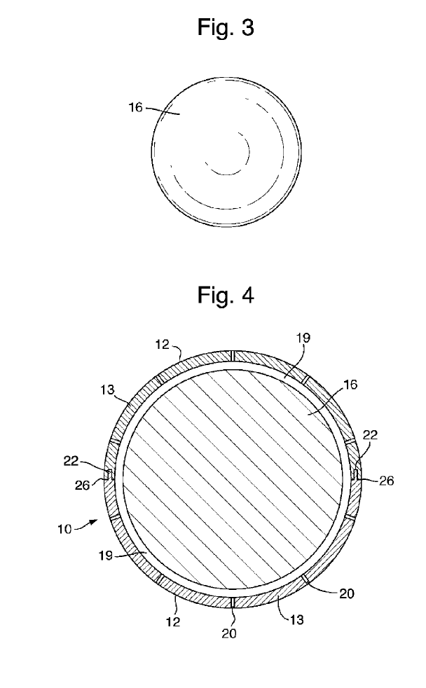

In FIGS. 1 and 2 a hemispherical shell piece is shown comprising carbon fibre lamellas composite board. It is one of two identical hemispherical shell pieces that would be used in the assembly a spherical acoustic reflector (10 in FIG. 3) used in connection with this invention. The core 16 of the reflector 10 is cast foamed RTF7000, which is a foamed RTV12 silicon elastomer and is shown in FIG. 3. The diameter of the core 16 is such that it is very slightly smaller, at ambient temperature, than the inside diameter of the shell when the two hemispherical shell pieces 13 are assembled together. There is a gap of about 1.3 mm between the core and the shell.

One or more holes 20 are provided in the hemispherical shell pieces 13. It is preferred that a large number of small holes each 1 to 2 mm in diameter be provided to ensure that all the internal air is vented from the inside of the reflector when it is immersed in waters and for water to fill any gaps between the inside of the shell and the core. In this example, altogether twenty four holes, twelve in each hemispherical shell piece are provided, but spheres made with more than five in each hemispherical shell piece operate satisfactorily, although the larger number ensures improved water access and air expulsion on immersion of the reflector in water.

Alternate upstanding tongues 22 and grooves 24, the tongue and grooves being of equal lengths, are provided continuously around the rim 26 the hemispherical shell pieces 13. The grooves are positioned to receive tongues of the other of a pair of hemispherical shell pieces. Two each of tongues and grooves are provided in this instance. When the two hemispherical shell pieces 13 are assembled together, tongues 22 of one hemispherical shell piece are received into grooves 24 in the other.

The core 16 is from a three part mix, initially is mixed and injected under pressure into a shaped mould to form the core and cured in a conventional way. The mould is overfilled leaving a sprue to reduce the opportunity for fissures to form. The sprue is then cut off once the core has cured. Subsequently the moulded core 16 is placed in one of the hemispherical shell pieces 13. A two part epoxy resin glue, such as Araldite®, is spread on the tongues 22 and in the grooves 24 of both hemispherical shell pieces 13 before the second hemispherical shell piece 13 is placed over the core 16 with the tongues 22 of one hemispherical shell piece engaging with the grooves 24 of the other hemispherical shell piece. This can be seen in more detail in FIG. 3. There is a small amount of rotational freedom of movement between the two hemispherical shell pieces which can be used to ensure that the glue is evenly spread over the tongues and grooves and air excluded before it cures. The pimples 18 hold the core 16 centrally within the shell 12, with a gap 19 between the inside of the shell 12 and the core 16. The end result is the acoustic reflector 10 illustrated as a cross section in FIG. 4.

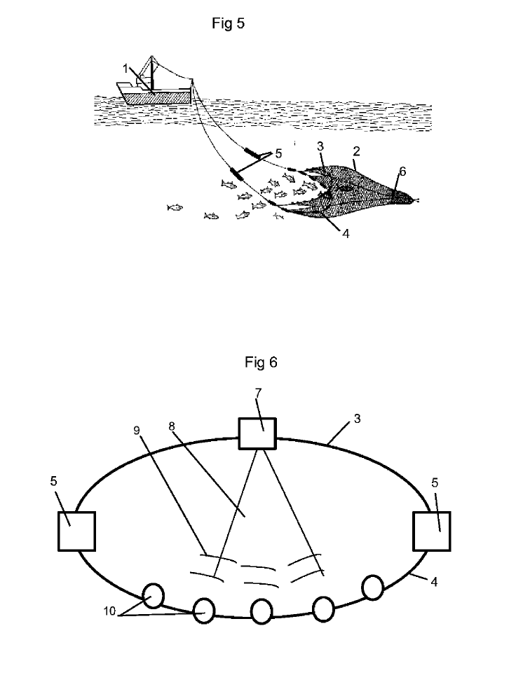

FIGS. 5 and 6 illustrate the application of the invention to trawl nets.

In FIG. 5, a trawler 1 has deployed a trawl net 2. The net 2 is attached to and is trailing a top rope 3 and bottom rope 4. The top and bottom ropes are connected to a pair of trawl doors 5; themselves connect by chains to the trawler 1. The exact arrangements for connecting the ropes 3 and 4 to the trawl doors 5 and the trawl doors 5 to the trawler 1, as well as the design of the trawl doors will depend on the trawling methodology being adopted and the catch being sought and FIG. 5 should be seen in that light., As the end 6 (which is usually tied and easily opened) of the net 2 fills the bottom rope 4 tends to drag behind the top rope 3 increasing the gap between the two.

The gap between the top rope and boom rope is monitored by a sonar transmitter and receiver set 7 mounted on the top rope 3 as shown in FIG. 6. The sonar transmits sonar pulses 8 towards the bottom rope 4. In the art the reflected acoustic signal from the bottom rope is often hard to distinguish from clutter, particularly when bottom trawling or operating in cloudy water. In this invention, however, the bottom rope is fitted with a plurality of passive acoustic reflectors 10 as described with reference to FIGS. 1 to 4, which provide a substantially enhanced reflected acoustic signal 9 easily picked up identified by the transmitter/receiver 7 and which can be monitored on board the trawler 1.

Although probably not necessary for use in the trawl net application is application but very useful in the downed aircraft application, a number of techniques for improving the prospects of positive identification of passive underwater acoustic reflectors of the kind described in the preceding paragraph are set out in WO 2012/101423 A (SUBSEA ASSET LOCATION TECHNOLOGIES LIMITED) Feb. 8, 2012 incorporated by reference.

1. An underwater acoustic reflector comprising a shell surrounding a core wherein said shell permits acoustic waves at one or more frequencies to pass, in part at least, through the shell into the core to be reflected back from the shell opposite the entry of the acoustic wave and in which the shell has one or more holes therein permitting water freely to enter and leave the inside of the shell when the reflector is deployed in water and in which the core comprises a foamed silicon elastomer and the shell a composite board material.

2. An underwater acoustic reflector according to claim 1 in which the core comprises foamed RTV12.

3. An underwater acoustic reflector according to claim 1 in which the shell comprises carbon fibre lamellas impregnated with epoxy resin and a two component thixotropic adhesive.

4. An underwater acoustic reflector according to claim 1 in which shell comprises a sandwich with glass fibre or carbon fibre sheet as covers and polymer honeycomb as a fill between the sheets.

5. An underwater acoustic reflector according to claim 1 in which the shell material comprises glass fibre lamellas impregnated with epoxy resin and a thixotropic adhesive.

6. An underwater acoustic reflector according to claim 1 in which the acoustic reflector weighs 1 kg or less

7. An underwater acoustic reflector according to claim 1 in which the acoustic velocity and the density of the foamed silicon elastomer is selected by the pressure applied to the foamed silicon elastomer during moulding.

8. An underwater acoustic reflector according to claim 7 in which the cores of the acoustic are formed at 1.5 bar pressure.

9. An underwater acoustic reflector according to claim 7 in which the core has an acoustic velocity of 890 m/s.

10. An underwater acoustic reflector according to claim 7 in which the ratio of acoustic velocity of the shell to the acoustic velocity of the core between 2.74 to 2.86.

11. An underwater acoustic reflector according to claim 1 in which the shells of the acoustic reflectors are between 9 mm and 11 mm thick inclusive.

12. An underwater acoustic reflector according to claim 11 in which the shells are 9 mm thick.

13. An underwater acoustic reflector according to claim 1 deployed with a trawl net.
